(19) United States
(12) Patent Application Publication
(10) Pub. No.: US 2022/0357750 A1
(43) Pub. Date: Nov. 10, 2022

(54) METHOD AND DEVICE FOR MAP EDITING

(71) Applicant: ALL RING TECH CO., LTD., KAOHSIUNG CITY (TW)

(72) Inventor: Li-Hsin CHEN, KAOHSIUNG CITY (TW)

(21) Appl. No.: 17/650,667

(22) Filed: Feb. 11, 2022

(30) Foreign Application Priority Data
May 5, 2021 (TW) 110116238

(51) Int. Cl. G05D 1/02; G05D 1/00

(52) U.S. Cl. CPC G05D 1/0274; G05D 1/0238; G05D 1/0044

(57) ABSTRACT

The present invention provides a method and a device for map editing, includes: controlling a robot to build a node at a predefined time interval and to save a submap produced by a scanning process performed by the robot on a workspace at each node, when the robot moves in the workspace; combining the submaps to obtain an entire map through a first algorithm, where plural node marks respectively representing the submaps are shown on the entire map; selecting two node marks having parts determined to be abnormal on the entire map, and showing the submaps represented by the two node marks; and overlapping parts having same structure features in the two submaps correspondingly, and combining the parts through a second algorithm, and applying the combined parts into the entire map again to form a corrected entire map.

### RELATED APPLICATION

This application claims priority to Taiwan Application Serial Number 110116238, filed May 5, 2021, which is herein incorporated by reference.

### BACKGROUND

### Technical Field

The present invention generally relates to an editing method and an editing device, and more particularly, relates to a method of map editing and a device of the same for editing the maps built by robots.

### Description of Related Art

As technology developed, manual labors for traditional jobs, such as cleaning, patrolling, and carrying are gradually replaced by robots. A conventional robot is capable of moving in a workspace, scanning physical structures in a workspace by using optical sensors such as LIDAR, and building the map having the structure features of the workspace with simultaneous localization and mapping (SLAM) for subsequently drawing up the work path of the robot based on the map. Since there may be plenty of uncertainties which lead to positioning deviation during the process of moving of the robot in the workspace, different structure features representing the same physical structure are shown on the map because of the positioning deviation, and thus the users need to implement the edit of map built by the robot again to match the current situation of the structure features of the map.

However, not only a great amount of experience but also lots of time and effort are required for the users when the users are editing the map, and the work of map editing cannot be accomplished conveniently and swiftly. Therefore, it has been a long-term issue for industry to research how to implement the map editing more efficiently.

### SUMMARY

Accordingly, the purpose of the present invention is to provide a more efficient method for map editing.

Another purpose of the present invention is to provide a device for executing the method of map editing mentioned above.

The method of map editing, according to the present invention, comprises: controlling a robot to build a node at a predefined time interval and to save a submap produced by a scanning process performed by the robot on a workspace at each node, when the robot moves in the workspace; combining the submaps to obtain an entire map through a first algorithm, where plural node marks respectively representing the submaps are shown on the entire map; selecting two node marks having parts determined to be abnormal on the entire map, and showing the submaps represented by the two node marks; and overlapping parts having same structure features in the two submaps correspondingly, and combining the parts through a second algorithm, and applying the combined parts into the entire map again to form a corrected entire map.

A map editing device according to another purpose of the present invention which is used for implementing the method of map editing mentioned above.

With the method and device for map editing provided in the present invention, the user only needs to select the node marks on the entire map to edit the submaps represented by the node marks, and can accomplish the work of map editing conveniently and swiftly.

### BRIEF DESCRIPTION OF THE DRAWINGS

FIG. 1 is a schematic diagram of a device for map editing in embodiments of the present invention.

FIG. 2 is a schematic diagram showing a workspace in the embodiments of the present invention.

FIG. 3 is a schematic diagram showing an entire map in the embodiments of the present invention.

FIG. 4 is a schematic diagram showing a first submap in the embodiments of the present invention.

FIG. 5 is a schematic diagram showing a second submap in the embodiments of the present invention.

FIG. 6 is a schematic diagram showing an entire map having abnormal parts indicated by the square frames in the embodiments of the present invention.

FIG. 7 is a schematic diagram showing the selection of a first feature point for finding the corresponding node mark in the embodiments of the present invention.

FIG. 8 is a schematic diagram showing the selection of a second feature point to find the corresponding node mark in the embodiments of the present invention.

FIG. 9 is a schematic diagram showing the selection of a first node mark to find the corresponding structure feature in the embodiments of the present invention.

FIG. 10 is a schematic diagram showing the selection of a second node mark to find the corresponding structure feature in the embodiments of the present invention.

FIG. 11 is a schematic diagram showing the selection of the first node mark and the second node mark in the embodiments of the present invention.

FIG. 12 is a schematic diagram showing that the first submap and the second submap do not overlap and match in the embodiments of the present invention.

FIG. 13 is a schematic diagram showing that the first submap and the second submap overlap and match in the embodiments of the present invention.

FIG. 14 is a schematic diagram showing the corrected entire map in the embodiments of the present invention.

FIG. 15 is a schematic diagram showing the entire map tallying with the current situation more in the workspace in the embodiments of the present invention.

### DETAILED DESCRIPTION

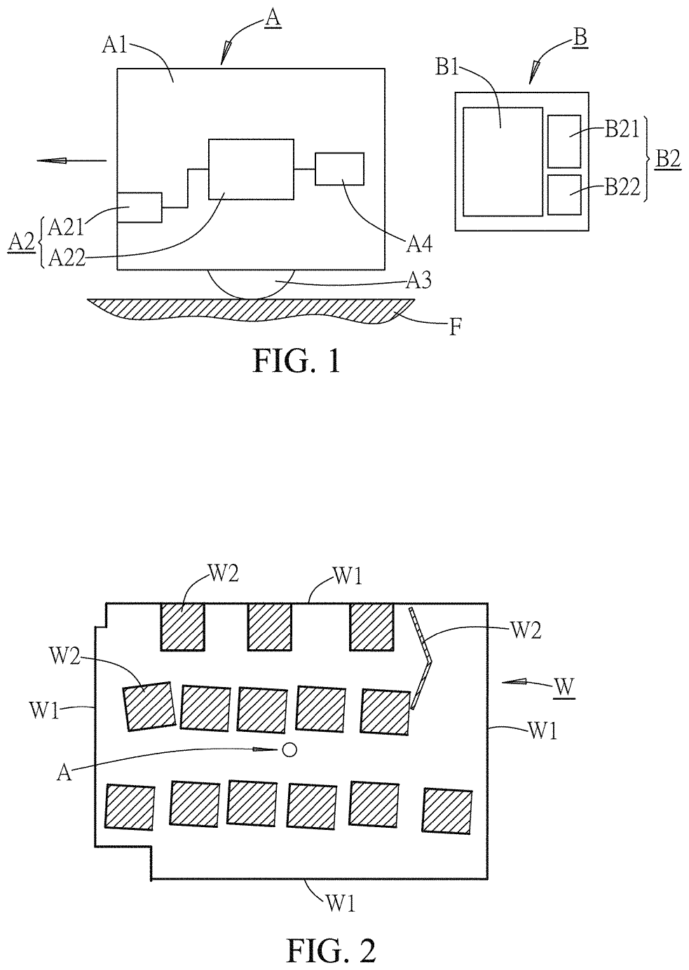

Referring to FIG. 1, the method for map editing in the embodiments of the present invention can be explained by taking the map editing device as shown in FIG. 1 as an example. The map editing device includes a robot A and a computer B.

Referring to FIG. 1 and FIG. 2, the robot A can move in a workspace W. The workspace W is defined by plural surrounding walls W1, and there are plural obstacles W2 in the workspace W. The robot A includes: a body A1, which can move in the workspace W:

a map building unit A2 disposed on the body A1; the map building unit A2 is provided with a sensor A21 such as LIDAR and a first processor A22; the sensor A21 is disposed at the front side of the body A1, and can scan the physical structures such as the walls W1 and the obstacles W2 confronted by the body A1 during moving of the body A1 in the workspace W, to receive the structure features of the illustrated physical features; the first processor A22 integrates the illustrated structure features through a first algorithm, to build the map of the workspace W, in other words, the structure features included in the map are corresponding to the physical features in the workspace W, for example, the walls W1 mentioned above and/or the obstacles W2 mentioned above;
a driving unit A3 disposed at the bottom of the body A1 and capable of driving the body A1 to execute the movement, for example going forward, going backward, rotating, etc., on the work surface F of the workspace W;
a control unit A4 disposed on the body A1 and capable of executing various data computations and execute various function controls of the robot A.

Referring to FIG. 1 and FIG. 2, after the robot A builds the map of the workspace W, the map of the workspace W can be transmitted to the computer B through the wired and wireless way for editing. In the embodiments of the present invention, the computer B is disposed outside the robot A, and does not move with the robot A, but the embodiments of the present invention are not limited thereto. The computer B can be also disposed on the robot A and move with the robot A; the computer B includes:
a display interface capable of showing the map of the workspace W;
an editing unit B2 including an operating component B21 and a second processor B22; the operating component B21 can be a combination of, for example, a key board, a mouse, etc., and can allow the user operationally selects the part which is desired to be edited in the map of the workspace W;
when the user is editing the map of the workspace W, the second processor B22 recombines the illustrated structure features through a second algorithm. In some embodiments, the first algorithm is a graph-building algorithm, and the second algorithm is a graph-editing algorithm. The graph-building algorithm can be, for example, technology of simultaneous localization and mapping based on pose graphs, thereby using the information(namely the appearances of physical features and the corresponding locations) received by the sensor A21 to build the map, the map hence includes the structure features corresponding to the physical features and the corresponding location information. For example, the sensor A21 can be used to scan the walls W1 and/or the obstacles W2 of the workspace W, in order to obtain the corresponding information of appearances and locations, and illustrate the map accordingly. In other words, the robot A collects the information needed for building the map by using the sensor A21, whereas the first processor A22 builds the map through the first algorithm in accordance with the information received by the sensor A21. The graph-editing algorithm can be, for example, technology of pose graph optimization, which can optimize the location and the direction of each structure feature on the map, and further correct the shape of the map.

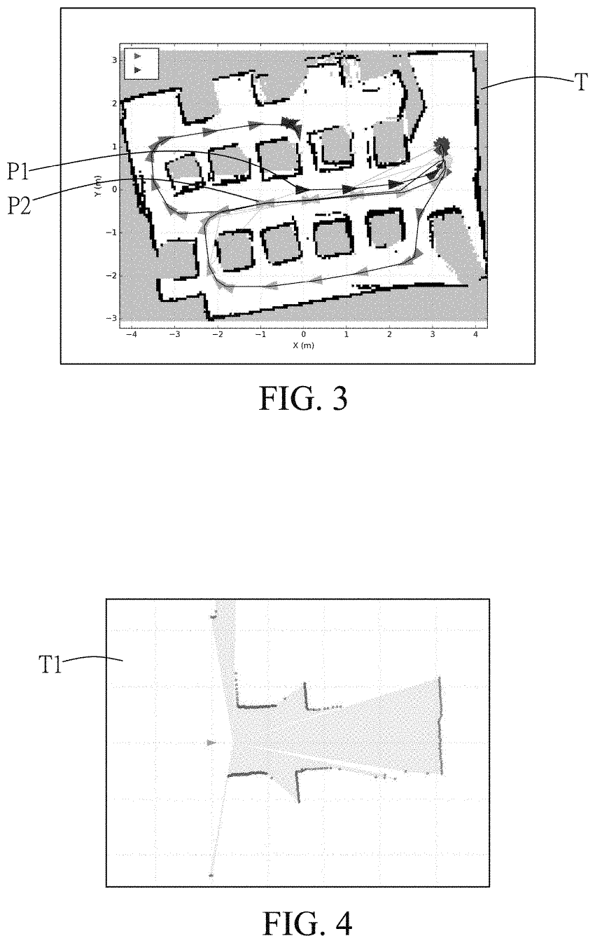

For the implementation of the method for map editing of the embodiments of the present invention, please refer to FIGS. 2, 3, 4 and 5. The user can control the robot A to move in the workspace W through remote control or manually pushing, and thus the robot A scans the physical feature of the workspace W to obtain the structure features of physical features and build an entire map T; in the entire map T, the dark patterns denote the structure features of the workspace W, the shallow patterns denote the regions the robot A has not scanned, the white patterns denote the regions the robot A has scanned, the triangle patterns denote the node marks.

The node marks are the marks produced when the robot A moves in the workspace W, built a node at each predefined time interval, and scanned the workspace W at each of the nodes to build a submap, in which indicative patterns such as triangles are used for the node marks to denote the directions the robot A moved in during the building of the nodes, and patterns with different colors are used for the node marks to denote the time axis of building the nodes.

The entire map T is formed by combining the submaps built by robot A at each node. Since there are lots of nodes in the entire map T, only a first node P1 and a second node P2 are used as an example for explanation. The robot A started from the first node P1 and then arrived at the second node P2 after passing through a lot of nodes, and the maps was built when the robot A is at the first node P1 and the second node P2 are denoted as a first submap T1 and a second submap T2 respectively; where in the first submap T1, the dark patterns denote the structure features of the workspace W, the shallow patterns denote the regions the robot A has scanned, the white patterns denote the regions the robot A has not scanned; where in the second submap T2, the dark patterns denote the structure features of the workspace W, the shallow patterns denote the regions the robot A has scanned, the white patterns denote the regions the robot A has not scanned.

Please refer to FIG. 6, since there may be plenty of uncertainties existing when robot A is moving in the workspace W and leading to different structure features for the same physical feature in the entire map T, as the places enclosed by the square frames, the users hence should edit the entire map T again, to make the structure features of the entire map T match the current situation more; wherein the places enclosed by the square frames have been determined as abnormal parts, they will not appear in the entire map T in practice.

Referring to FIGS. 1, 7 and 8, the entire map T can be presented on the display interface B1 to allow the user to observe visually and to implement editing by using editing unit B2, the user can also locally zoom in or zoom out the entire map T based on their needs.

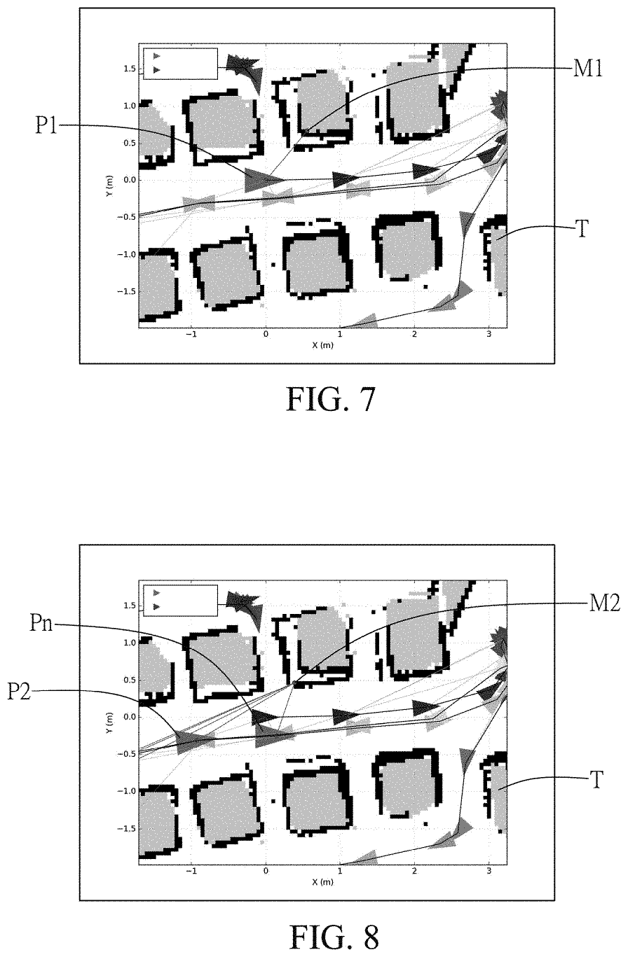

When the users are editing the entire map T, it is needed to find out the node from which the structure feature desired to be edited come at first. The user can select the structure feature desired to be edited by using the operating component B21, and the second processor B22 can find out the node at which the structure features desired to be edited is built by using the second algorithm. In FIG. 7, the first feature point M1 is the structure feature selected by the user, and it is known that the first feature point M1 is built at the first node P1. In FIG. 8, the second feature point M2 is the structure feature selected by the user, and it is known that the second feature point M2 is built at the second node P1 and other nodes Pn, in which corresponding node marks are denoted as different patterns (different colors and different sizes) on the entire map T when the structure features on the entire map T are selected, to enable swift identification between the plenty of node marks for the user.

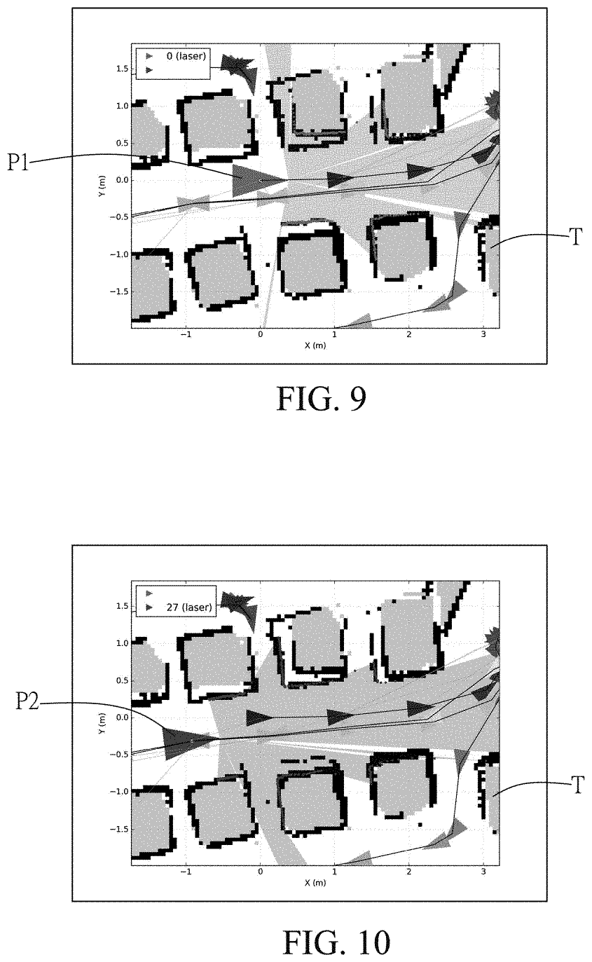

Referring to FIGS. 9 and 10, after finding out the nodes corresponding to the structure features desired to be edited, the user can select each of the node marks to check the structure features again, in which the node marks are denoted as different patterns (different colors and different sizes) and the structure features on the entire map T are denoted as different patterns (different colors) when the node marks on the entire map T are selected.

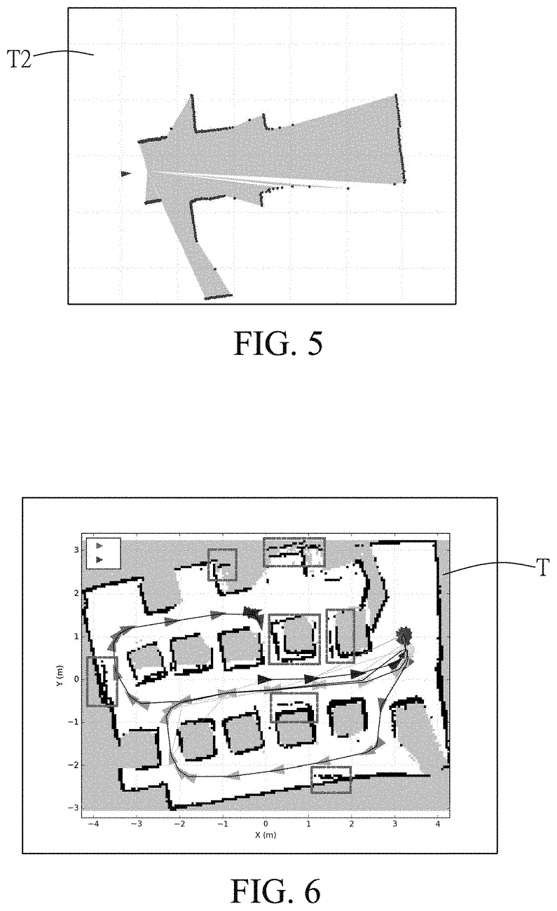

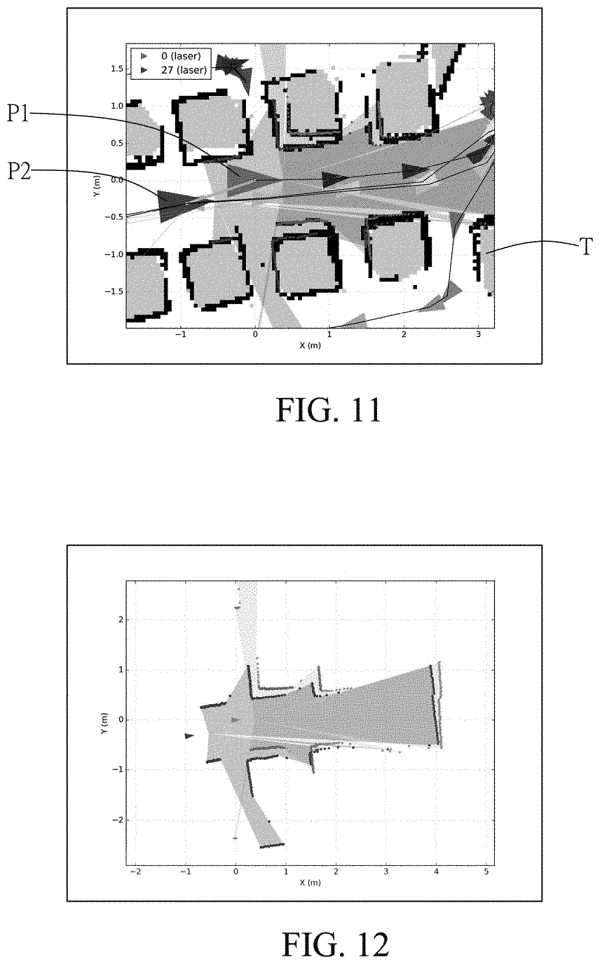

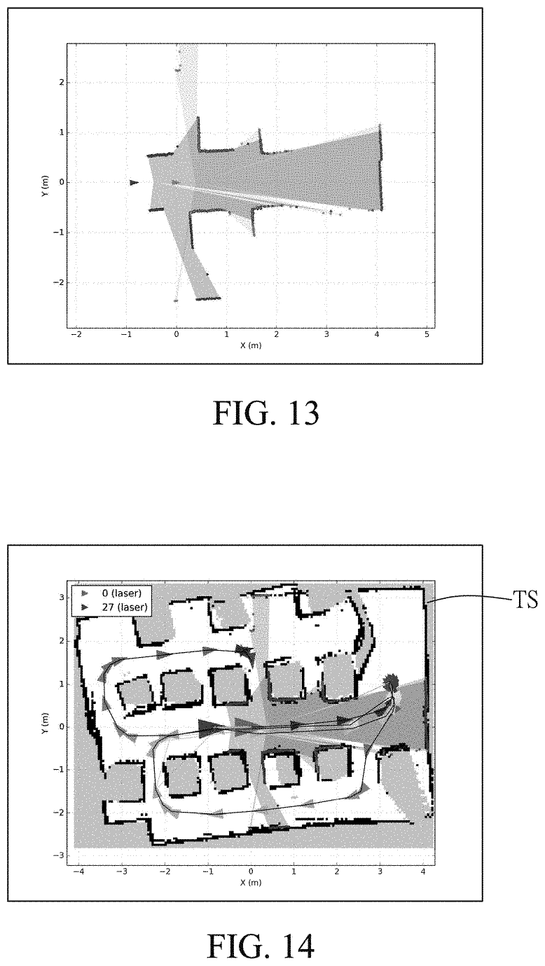

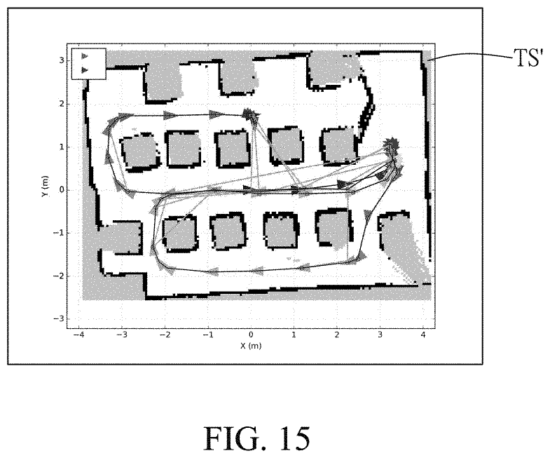

Referring to FIGS. 11, 12, 13, 14 and 15, after the structure features desired to be edited is selected, the user select the two node marks determined to have abnormal parts on the entire map T to perform the editing. The structure features corresponding to the two node marks are similar and close to each other. In the embodiments of the present invention, the first node P1 and the second node P2 are selected as edit target by the user, and the display interface B1 (FIG. 1) is switched to show the first submap T1 (FIG. 4) represented by the first node P1 and the second submap T2 (FIG. 5) represented by the second node P2, and the parts having same structure features in the first submap T1 and second submap T2 are overlapped correspondingly and combined through the second algorithm, and the combined parts are applied into the entire map T again to form the corrected entire map TS. Optimization is continuously performed on the corrected entire map TS according to the above mentioned editing logic, thereby completing an entire map TS' matching the current situation of work environment (FIG. 2) more in the final.

For the method and device for map editing in the embodiments of the present invention, the user only need to select the node marks of the entire map T to edit the submaps represented by the node marks, and can accomplish the work of map editing swiftly and conveniently.

However, the present disclosure illustrated above is solely for the better example, and is not intended to limit the scope of the present invention, that is, in general, such easy equivalent variations and modifications in accordance with the claims and the detailed description of the present invention are still covered by the scope of the present invention.

What is claimed is:

1. A method for map editing, comprising:
controlling a robot to build a node at a predefined time interval and to save a submap produced by a scanning process performed by the robot on a workspace at each node, when the robot moves in the workspace;
combining the submaps to obtain an entire map through a first algorithm, where plural node marks respectively representing the submaps are shown on the entire map;
selecting two node marks having parts determined to be abnormal on the entire map, and showing the submaps represented by the two node marks; and
overlapping parts having same structure features in the two of the submaps correspondingly, and combining the parts through a second algorithm, and applying the combined parts into the entire map again to form a corrected entire map.

2. The method of claim 1, wherein the entire map and the submap are shown on a display interface.

3. The method of claim 2, wherein the node marks use indicative patterns to denote directions the robot moved in when the robot builds the nodes.

4. The method of claim 2, wherein the node marks use different patterns to denote time axes when the nodes are built.

5. The method of claim 2, wherein when one of the node marks on the entire map is selected, the structure features corresponding to the selected one of the node marks on the entire map are denoted as different patterns.

6. The method of claim 2, wherein the node marks on the entire map are denoted as different patterns when the node marks on the entire map are selected.

7. The method of claim 2, wherein when one of the structure features on the entire map is selected, the corresponding node marks on the entire map are denoted as different patterns.

8. The method of claim 1, wherein the first algorithm is executed on the robot.

9. The method of claim 2, wherein the second algorithm is executed on a computer having the display interface.

10. The method of claim 1, wherein the structure features included in each of the submaps correspond to physical structures of the workspace.

11. The method of claim 10, wherein the structure features included in each of the submaps correspond to walls and obstacles of the workspace.

12. A map editing device, used to implement the method of claim 1.

13. A map editing device, used to implement the method of claim 2.

14. A map editing device, used to implement the method of claim 3.

15. A map editing device, used to implement the method of claim 4.

16. A map editing device, used to implement the method of claim 5.

17. A map editing device, used to implement the method of claim 6.

18. A map editing device, used to implement the method of claim 7.

19. A map editing device, used to implement the method of claim 8.

20. A map editing device, used to implement the method of claim 9.
